(19) United States
(12) Patent Application Publication
(10) Pub. No.: US 2019/0083362 A1
(43) Pub. Date: Mar. 21, 2019

(54) Pocket spittoon for tobacco users

(71) Applicant: Daniel Darrell Hales, Aurora, CO (US)

(72) Inventor: Daniel Darrell Hales, Aurora, CO (US)

(73) Assignee: Daniel Darrell Hales, Denver, CO (US)

(21) Appl. No.: 16/148,661

(22) Filed: Dec. 3, 2018

(51) Int. Cl. A61J 19/02

(52) U.S. Cl. CPC A61J 19/02

(57) ABSTRACT

The invention is directed to a pocket spittoon for tobacco users. The spittoon is configured in the form of a cylinder with rounded edges, terminating in a removable, watertight cap secured by screw threads. An aperture is provided in the cap, covered by a watertight lid, such that the user may discreetly open the aperture and expel saliva and used tobacco into the spittoon. The spittoon further provides a disposable absorbent liner which will contain the saliva and used tobacco.

### CROSS-REFERENCE TO RELATED APPLICATIONS

Not Applicable

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to tobacco accessories and in particular to a pocket spittoon for tobacco users. For those who use chewing tobacco, a variety of social challenges can arise due to their generation of substantial amounts of saliva and used tobacco. Non-users find the odor of these waste products to be unpleasant, or even disgusting, and their brown coloration can also appear unpleasant. Many users have developed the habit of using a disposable cup or an empty 12-ounce beverage can as a personal spittoon, but these are easily knocked over, creating an unsightly mess that must be cleaned up. A leakproof container which can be used indefinitely, and would contain the odor, would be very useful for such individuals. A pocket spittoon for tobacco users, which provides a disposable absorbent liner and an aperture for saliva and used tobacco that is covered by a watertight lid, would resolve these problems.

### SUMMARY OF THE INVENTION

Accordingly, the invention is directed to a pocket spittoon for tobacco users. The spittoon is configured in the form of a cylinder with rounded edges, terminating in a removable, watertight cap secured by screw threads. An aperture is provided in the cap, covered by a watertight lid, such that the user may discreetly open the aperture and expel saliva and used tobacco into the spittoon. The spittoon further provides a disposable absorbent liner which will contain the saliva and used tobacco.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate two embodiments of the invention and together with the description, serve to explain the principles of the invention.

FIG. 1 is a side view of the first exemplary embodiment with the cap removed, displaying the spittoon 10, the cap 11, the screw threads 12, the liner 13, and the button 14.

FIG. 2 is a side view of the cap and liner of the first exemplary embodiment, displaying the cap 11, the screw threads 12, the liner 13, and the button 14.

FIG. 3 is a side perspective view of the first exemplary embodiment, displaying the spittoon 10, the cap 11, the button 14, the aperture 15, and the lid 16.

FIG. 4 is a side view of the first exemplary embodiment, displaying the spittoon 10, the cap 11, and the button 14.

FIG. 5 is a top view of the first exemplary embodiment, displaying the cap 11, the aperture 15, and the lid 16.

FIG. 6 is a side view of the second exemplary embodiment with the cap removed, displaying the spittoon 10, the cap 11, the screw threads 12, the liner 13, and the lid 16.

FIG. 7 is a side view of the cap and liner of the second exemplary embodiment, displaying the cap 11, the screw threads 12, the liner 13, and the lid 16.

FIG. 8 is a side perspective view of the second exemplary embodiment, displaying the spittoon 10, the cap 11, the button 14, the lid 16, and the hinge 17.

FIG. 9 is a side perspective view of the first exemplary embodiment with the lid opened, displaying the spittoon 10, the cap 11, the button 14, the aperture 15, the lid 16, and the hinge 17.

FIG. 10 is a top view of the first exemplary embodiment, displaying the cap 11, the button 14, the lid 16, and the hinge 17.

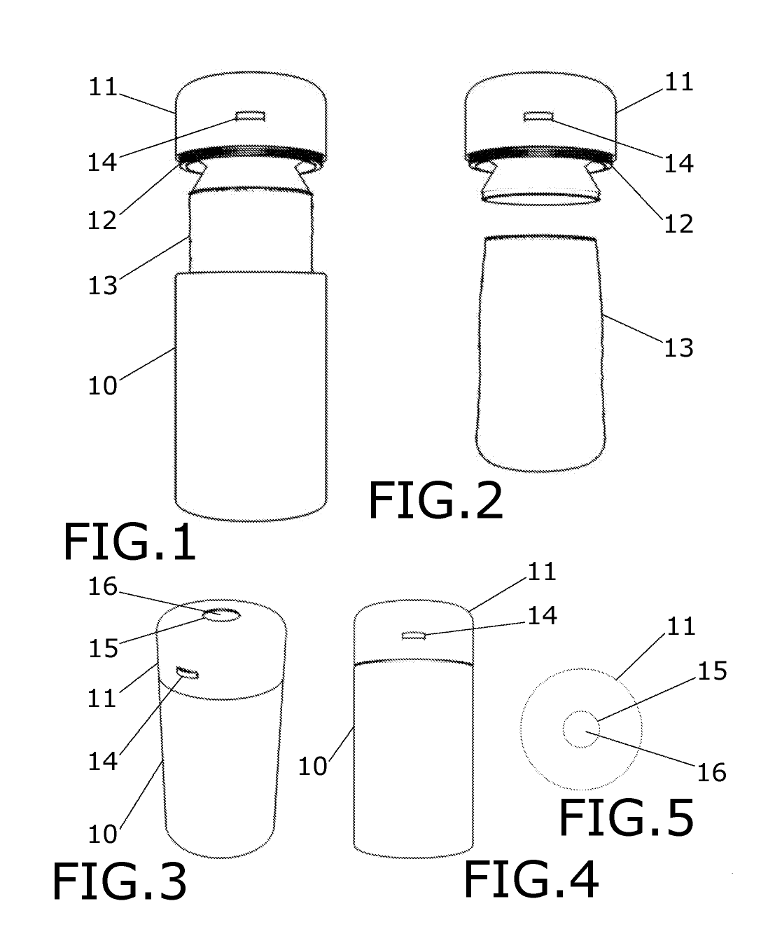

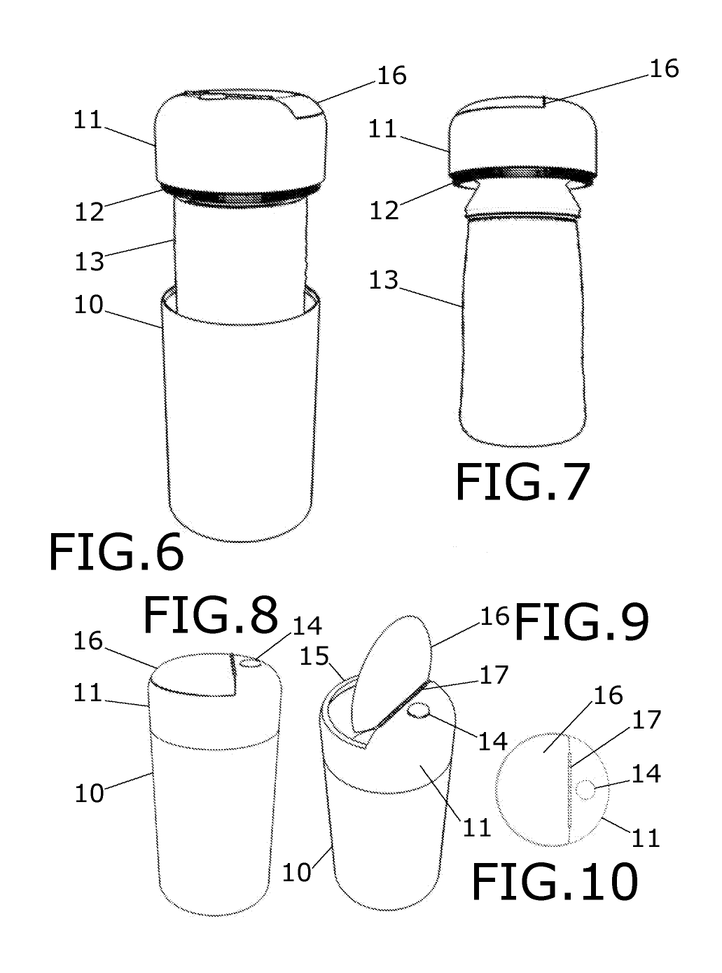

### DETAILED DESCRIPTION OF THE INVENTION

Referring now to the invention in more detail, the invention is a pocket spittoon 10 for tobacco users.

The first exemplary embodiment is comprised of a spittoon 10 which is configured in the form of a cylinder with rounded edges, terminating in a removable, watertight cap 11 secured by screw threads 12. An aperture 15 is provided in the cap 11, covered by a watertight lid 16 which is operated by a button 14, such that the user may discreetly open the aperture 15 and expel saliva and used tobacco into the spittoon 10. The spittoon 10 further provides a disposable absorbent liner 13 which will contain the saliva and used tobacco. In the first exemplary embodiment, the aperture 15 is circular and located at the center of the top surface of the cap 11, with a sliding lid 16 which withdraws laterally into the cap 11.

The cap 11 can be removed, and the liner 13 removed and discarded with its contents. The liner 13 provides a string which, when pulled, separates the liner 13 from the cap 11 and may be used to discard the liner 13 without soiling the user's hands. Replacement liners 13 are made available separately.

The second exemplary embodiment is similar in structure and function to the first exemplary embodiment, with the following modifications. The aperture 15 is offset to the edge of the top surface of the cap 11, and is D-shaped. The lid 16 flips upward when released by pressing the button 14 and is secured to the cap 11 by a hinge 17.

To use the first or the second exemplary embodiment, the user may carry the spittoon 10 in the user's pocket or elsewhere. The user may then open the lid 11 by pressing the button 14 and may expel saliva, used tobacco, or both through the aperture 15 and into the liner 13.

The spittoon 10, the cap 11, the button 14, and the hinge 17 are preferably manufactured from rigid, durable materials which are corrosion resistant and may provide a decorative quality, such as brushed nickel, sterling silver, brass, stainless steel, and polished hardwood. The liner 13 is preferably manufactured from a flexible, disposable material which is waterproof, such as plastic or nylon, lined with a flexible, disposable material which is absorbent, such as paper.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

1. The spittoon is configured in the form of a cylinder with rounded edges, terminating in a removable, watertight cap secured by screw threads.

2. The spittoon further provides a disposable absorbent liner which will contain the saliva and used tobacco.
